(19) United States
(12) Patent Application Publication
(10) Pub. No.: US 2015/0016100 A1
(43) Pub. Date: Jan. 15, 2015

(54) Luminaire

(71) Applicant: Toshiba Lighting & Technology Corporation, Yokosuka-shi (JP)

(72) Inventor: Yasuhiko Ishii, Yokosuka-shi (JP)

(21) Appl. No.: 14/210,991

(22) Filed: Mar. 14, 2014

(30) Foreign Application Priority Data
Jul. 5, 2013 (JP) 2013-141404

(51) Int. Cl. F21S 8/04; F21V 21/116; F21V 21/13; F21S 9/00; F21V 7/05

(52) U.S. Cl. CPC F21S 8/043; F21S 9/00; F21V 7/05; F21V 21/13; F21V 21/116; F21Y 2101/00
USPC 362/223

(57) ABSTRACT

According to one embodiment, there is provided a luminaire including a light source module, a power supply device, and a luminaire main body. The light source module includes a board, a light source provided on the board, a supporting body supporting the board, and a light transmissive cover covering the board and has a long shape. The power supply device supplies electric power to the light source module. The luminaire main body is provided with the light source module and the power supply device and has a long shape. The luminaire main body includes a pair of reflecting plate sections and a housing section provided between the pair of reflecting plate sections and housing at least a part of the power supply device. The light source module is provided in the luminaire main body with the supporting body and covers the housing section and the power supply device.

### CROSS-REFERENCE TO RELATED APPLICATIONS

This application is based upon and claims the benefit of priority from Japanese Patent Application No. 2013-141404, filed on Jul. 5, 2013; the entire contents of which are incorporated herein by reference.

### FIELD

Embodiments described herein relate generally to a luminaire.

### BACKGROUND

There is a luminaire attached to a ceiling or the like to illuminate a room. As the room luminaire, there is a luminaire including a light source module and a luminaire main body configured to support the light source module. The light source module includes a supporting body configured to support a board including a light source and a cover configured to cover the board provided on the supporting body. In such a luminaire, improvement of assemblability is desired.

### BRIEF DESCRIPTION OF THE DRAWINGS

FIG. 1A and FIG. 1B are perspective views schematically showing a luminaire according to an embodiment;

FIG. 2A and FIG. 2B are perspective views schematically showing a light source module according to the embodiment;

FIG. 3 is an exploded perspective view schematically showing the light source module;

FIG. 4A and FIG. 4B are sectional views schematically showing the light source module;

FIG. 5 is an enlarged partial perspective view schematically showing a part of the light source module;

FIG. 6A and FIG. 6B are schematic diagrams of a luminaire main body of the luminaire;

FIG. 7A and FIG. 7B are schematic diagrams showing a part of the luminaire;

FIG. 8 is a partial sectional view schematically showing a part of the luminaire;

FIG. 9 is a partial plan view schematically showing a part of the luminaire; and

FIG. 10A and FIG. 10B are schematic diagrams showing another luminaire main body of the luminaire.

### DETAILED DESCRIPTION

In general, according to one embodiment, there is provided a luminaire including a light source module, a power supply device, and a luminaire main body. The light source module includes a board, a light source provided on the board, a supporting body configured to support the board, and a light transmissive cover configured to cover the board and has a long shape. The power supply device supplies electric power to the light source module. The luminaire main body is provided with the light source module and the power supply device and has a long shape. The luminaire main body includes a pair of reflecting plate sections and a housing section provided between the pair of reflecting plate sections and configured to house at least a part of the power supply device. The light source module is provided in the luminaire main body with the supporting body opposed to the housing section and covers the housing section and the power supply device.

Various embodiments will be described hereinafter with reference to the accompanying drawings.

The drawings are schematic or conceptual. Relations between thicknesses and widths of sections, ratios of the sizes among the sections, and the like are not always the same as real ones. Even if the same sections are shown, dimensions and ratios of the sections may be shown differently depending on the drawings.

In this specification and the drawings, components same as the components already shown in the drawings and explained are denoted by the same reference numerals and signs and detailed explanation of the components is omitted as appropriate.

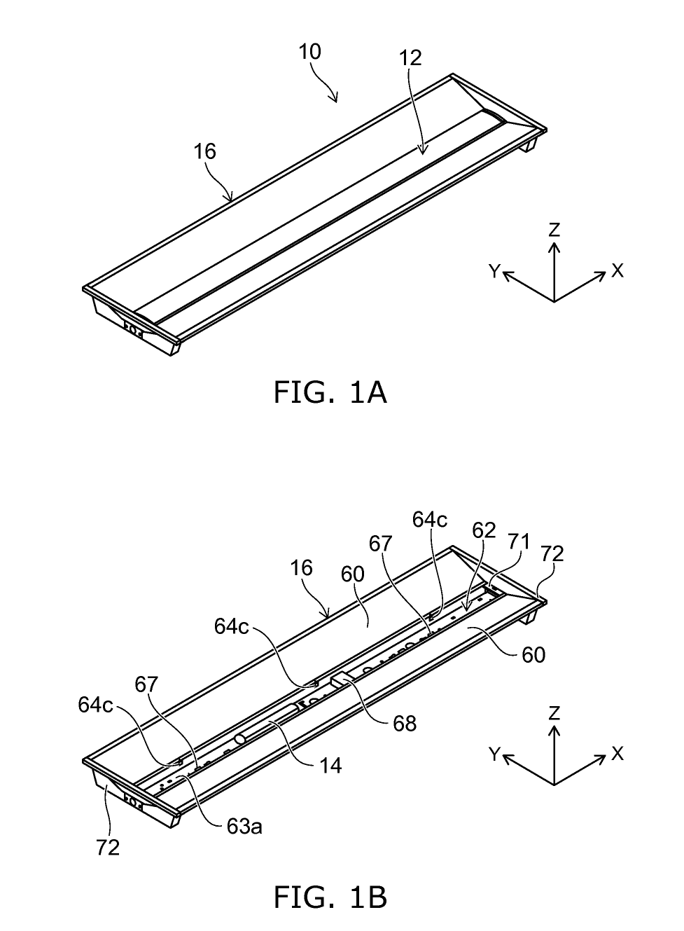

FIG. 1A and FIG. 1B are perspective views schematically showing a luminaire according to an embodiment.

As shown in FIG. 1A and FIG. 1B, a luminaire 10 includes a light source module 12, a power supply device 14, and a luminaire main body 16. FIG. 1B shows a state in which the light source module 12 is detached.

The light source module 12 includes a light source. The power supply device 14 converts electric power supplied from the outside into electric power corresponding to the light source module 12 and supplies the converted electric power to the light source module 12. The light source module 12 lights the light source according to the supply of the electric power from the power supply device 14 and radiates light.

The luminaire main body 16 supports the light source module 12 and the power supply device 14. In this example, the power supply device 14 is attached to the luminaire main body 16. The power supply device 14 may be attached to the light source module 12. That is, the luminaire main body 16 may directly support the power supply device 14 or may support the power supply device 14 via the light source module 12.

The luminaire 10 is attached to, for example, a ceiling in a room with the light source module 12 faced down. The luminaire 10 illuminates the room with light radiated from the light source module 12. The luminaire 10 is not limitedly attached to the ceiling and may be attached to, for example, a wall surface.

Metal fittings such as hanging bolts are attached to the luminaire main body 16. The luminaire 10 is attached to the ceiling via the metal fittings. For example, the luminaire 10 is attached to the ceiling to be substantially flush with a ceiling surface. That is, the luminaire 10 is a so-called embedded luminaire. For example, the luminaire main body 16 may be attached to the ceiling from the indoor side by screws or the like. That is, the luminaire 10 may be a so-called luminaire fixture for the ceiling. In this way, the luminaire main body 16 is used to support the light source module 12 and the power supply device 14 and is used to attach the luminaire 10 to an attachment target such as the ceiling.

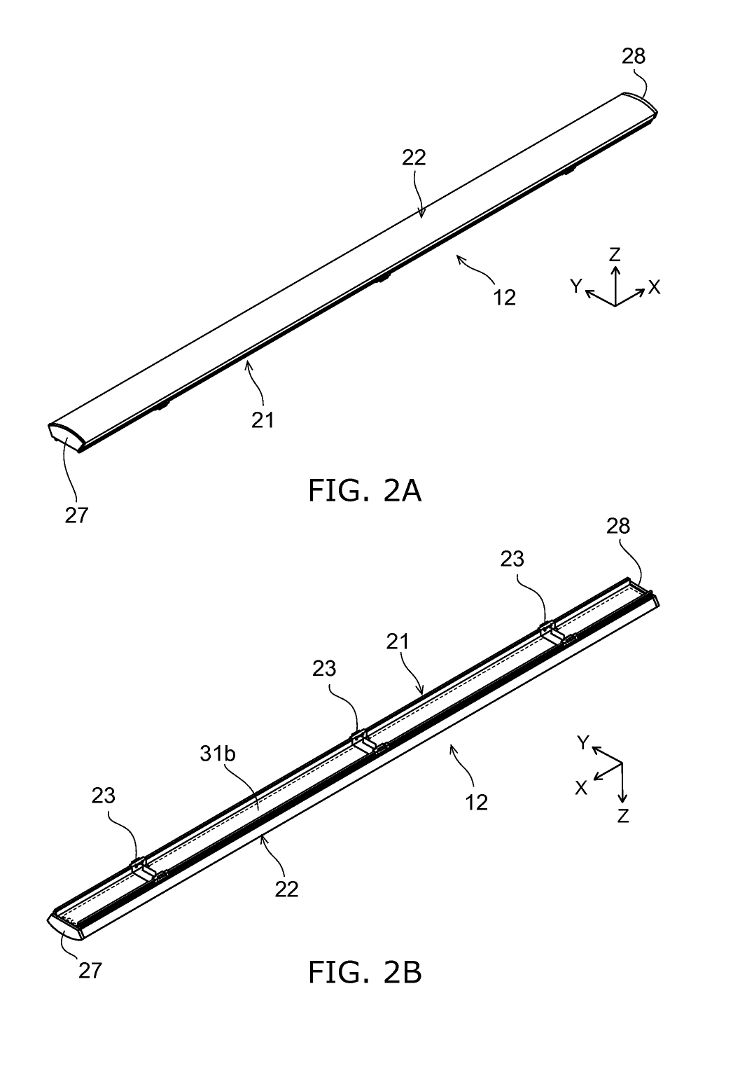

FIG. 2A and FIG. 2B are perspective views schematically showing the light source module according to the embodiment.

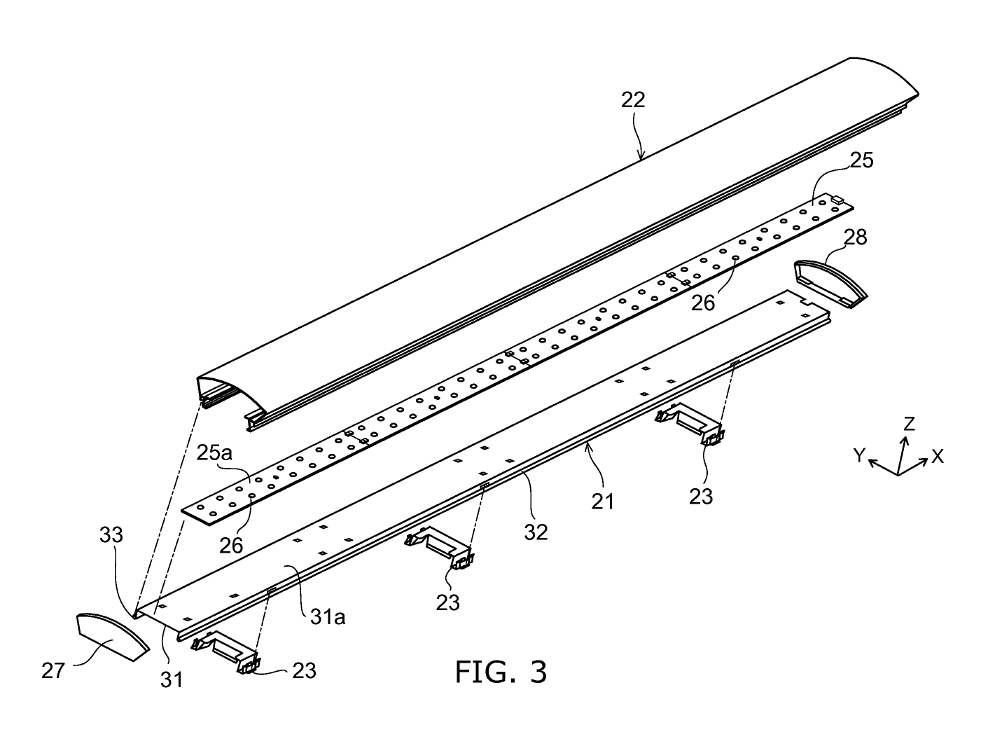

FIG. 3 is an exploded perspective view schematically showing the light source module.

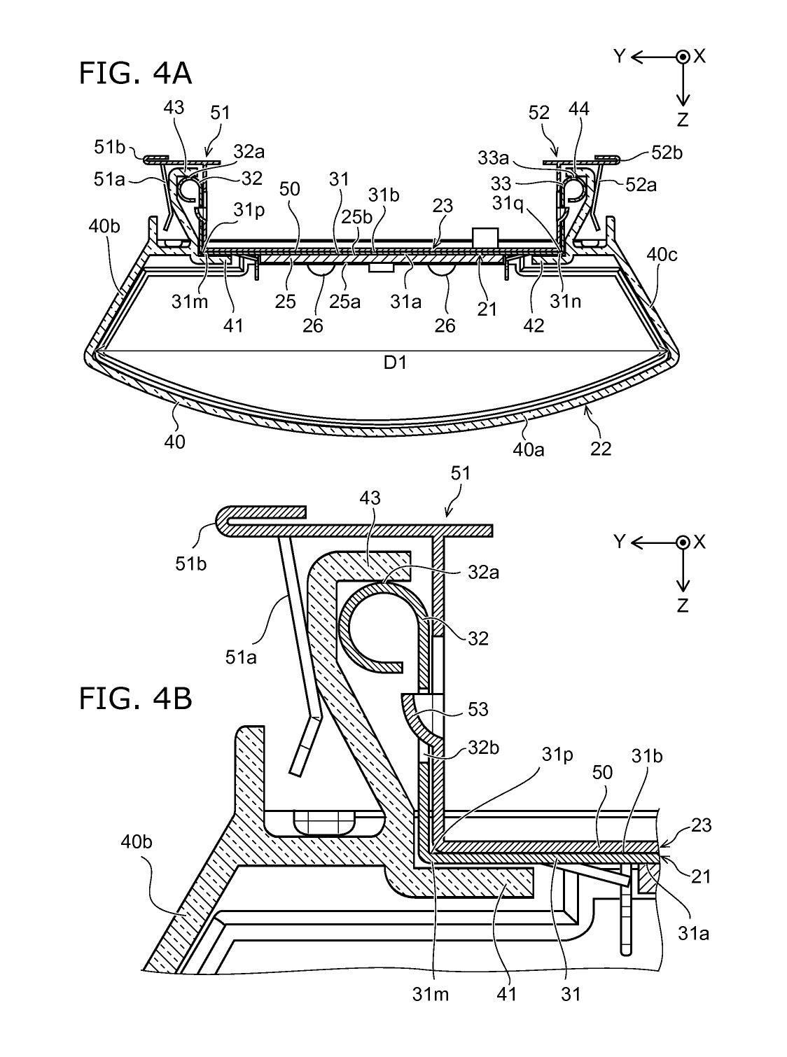

FIG. 4A and FIG. 4B are sectional views schematically showing the light source module.

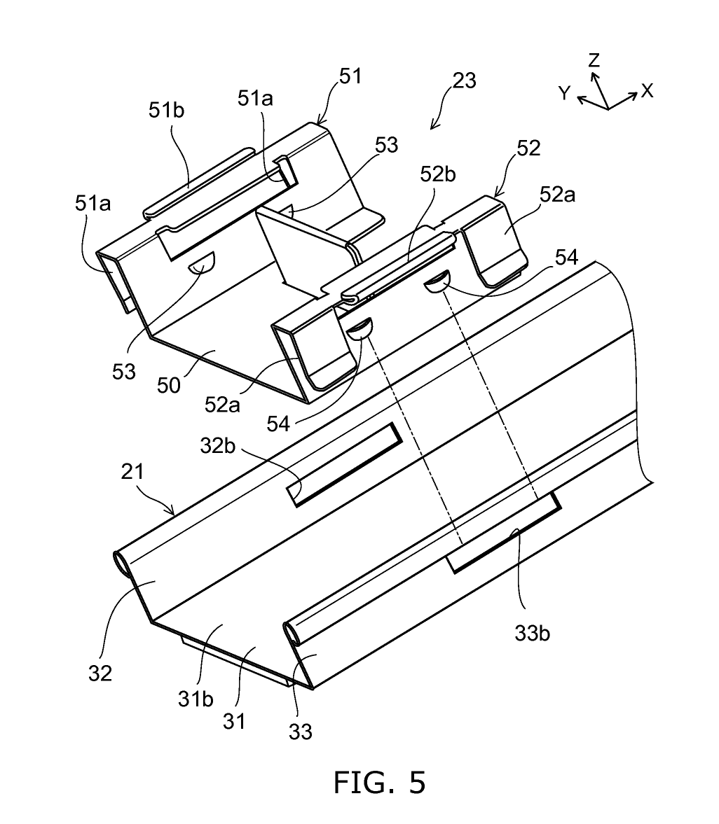

FIG. 5 is an enlarged partial perspective view schematically showing a part of the light source module.

As shown in FIG. 2A to FIG. 5, the light source module 12 includes a supporting body 21, a cover 22, and a holding member 23.

The supporting body 21 supports a board 25. The board 25 includes a first surface 25a and a second surface 25b. The second surface 25b is a surface on the opposite side of the first surface 25a. The supporting body 21 supports the board 25 from the second surface 25b side. The board 25 may be fixed to the supporting body 21 by bonding or the like or may be detachably attached to the supporting body 21 by screwing or the like. The supporting body 21 may detachably support the board 25.

A light source 26 is provided on the board 25. For example, a plurality of the light sources 26 are provided on the board 25. The light sources 26 are arranged side by side on the first surface 25a of the board 25. For example, a not-shown wiring layer is provided on the board 25. The light sources 26 are electrically connected to one another via the wiring layer. The number of the light sources 26 may be arbitrary. The number of the light sources 26 may be, for example, one.

As the light source 26, for example, a light-emitting diode (LED) is used. The light source 26 may be, for example, an organic light-emitting diode (OLED), an inorganic electroluminescence light-emitting element, an organic electroluminescence light-emitting element, or other field emission light-emitting elements. The light source 26 may be, for example, a bulb.

The cover 22 is attached to the supporting body 21 and covers the board 25 supported by the supporting body 21. The cover 22 protects the board 25 and the light sources 26 from, for example, an external force and dust. The cover 22 has light transmissivity. The cover 22 is light transmissive with respect to lights emitted by the light sources 26. The cover 22 is, for example, transparent. The cover 22 may have, for example, light diffusibility. For the cover 22, for example, a light transmissive resin material is used.

The holding member 23 retains the cover 22 on the supporting body 21. That is, the holding member 23 prevents the cover 22 from coming off the supporting body 21. For example, a plurality of the holding members 23 are provided in the light source module 12. In this example, a trio of the holding members 23 are provided. The number of the holding members 23 may be arbitrary. The number of the holding members 23 may be, for example, one or two or may be four or more.

The supporting body 21 includes a first section 31, a second section 32, and a third section 33. The first section 31 includes a front surface 31a extending in a first direction and a rear surface 31b on the opposite side of the front surface 31a. The first section 31 is tabular. The first section 31 is a long plate long in the first direction. In this example, the front surface 31a and the rear surface 31b have a substantially rectangular shape. The shapes of the front surface 31a and the rear surface 31b are not limited to the rectangular shape and may be an arbitrary shape extending in the first direction. In this example, the rear surface 31b is substantially parallel to the front surface 31a.

In the following explanation, a direction indicated by an arrow X in the figure and parallel to the first direction (an X-axis direction) is referred to as “longitudinal direction”. A direction indicated by an arrow Y in the figure and parallel to the front surface 31a and perpendicular to the longitudinal direction (a Y-axis direction) is referred to as “width direction”. A direction indicated by an arrow Z in the figure and perpendicular to the longitudinal direction and the width direction (a Z-axis direction) is referred to as “height direction”. The height direction is a direction perpendicular to the front surface 31a.

The second section 32 is provided at one side end 31p of the rear surface 31b extending in the longitudinal direction. The second section 32 extends in a direction that the rear surface 31b faces. In other words, the second section 32 extends in a direction from the front surface 31a to the rear surface 31b.

The third section 33 is provided at the other side end 31q of the rear surface 31b extending in the longitudinal direction. The third section 33 extends in a direction that the rear surface 31b faces.

In this example, the shape of the supporting body 21 viewed in the longitudinal direction is a substantial U shape. The second section 32 and the third section 33 are so-called ribs. The shape of the supporting body 21 viewed in the longitudinal direction may be, for example, an H shape. That is, the second section 32 and the third section 33 only have to extend at least in the direction that the rear surface 31b faces and may further extend in a direction that the front surface 31a faces. In this example, the second section 32 and the third section 33 extend in a direction substantially perpendicular to the rear surface 31b. The second section 32 and the third section 33 may incline with respect to the rear surface 31b. For the supporting body 21, a meal material such as iron, aluminum, or stainless steel is used. The supporting body 21 is formed by, for example, bending a metal plate.

In this example, in the supporting body 21, one second section 32 extending in the longitudinal direction along one side end 31p of the rear surface 31b is provided. One third section 33 extending in the longitudinal direction along the other side end 31q of the rear surface 31b is provided. The sections of the supporting body 21 are not limited to this. For example, a plurality of the second sections 32 arranged side by side in the longitudinal direction may be provided or a plurality of the third sections 33 arranged side by side in the longitudinal direction may be provided.

The supporting body 21 supports the board 25 on the front surface 31a. The board 25 is provided on the front surface 31a. The supporting body 21 supports the board 25 with the first surface 25a of the board 25 directed in a direction that the front surface 31a faces. Consequently, light is radiated in the direction that the front surface 31a faces.

The width (the length in the width direction) of the front surface 31a is larger than the width of the board 25. Therefore, one end portion 31m of the front surface 31a extending in the longitudinal direction and the other end portion 31n of the front surface 31a extending in the longitudinal direction are not covered by the board 25 even in a state in which the board 25 is supported.

The cover 22 includes a main body section 40, a first contact section 41, a second contact section 42, a first engaging section 43, and a second engaging section 44.

The main body section 40 is opposed to the first surface 25a of the board 25 supported on the front surface 31a and covers the board 25. The main body section 40 includes, for example, a first plate section 40a opposed to the first surface 25a, a second plate section 40b extending from one end in the width direction of the first plate section 40a to the first surface 25a side, and a third plate section 40c extending from the other end in the width direction of the first plate section 40a to the first surface 25a side.

In this example, the second plate section 40b and the third plate section 40c incline with respect to the first surface 25a. The second plate section 40b and the third plate section 40c are inclining sections inclining to expand from the board 25 side to an emitting direction of light of the light source 26 in the width direction of the light source module 12. A distance D1 in the width direction between the second plate section 40b and the third plate section 40c increases in a direction from the first surface 25a to the first plate section 40a (the light emitting direction). The distance D1 in the width direction between the second plate section 40b and the third plate section 40c continuously increases, for example, in the direction from the first surface 25a to the first plate section 40a. That is, the second plate section 40b and the third plate section 40c have a taper shape. The shape of the main body section 40 viewed in the longitudinal direction is, for example, a fan shape. Consequently, for example, when the light source module 12 is set on the ceiling, a part of light radiated from the light source module 12 travels from the second plate section 40b and the third plate section 40c to the ceiling side.

The first contact section 41 is provided at one end in the width direction of the main body section 40. The first contact section 41 is provided, for example, at an end portion of the second plate section 40b on the opposite side of the first plate section 40a. The first contact section 41 is in contact with one side end 31m of the front surface 31a.

The second contact section 42 is provided at the other end in the width direction of the main body section 40. The second contact section 42 is provided, for example, at an end portion of the third plate section 40c on the opposite side of the first plate section 40a. The second contact section 42 is in contact with the other side end 31n of the front surface 31a.

In this example, the first contact section 41 and the second contact section 42 are in direct contact with the front surface 31a. The first contact section 41 and the second contact section 42 do not have to always in direct contact with the front surface 31a. The first contact section 41 and the second contact section 42 may be in contact with the front surface 31a via another member.

The first engaging section 43 is provided at one end in the width direction of the main body section 40. The first engaging section 43 engages with an end portion 32a in the height direction of the second section 32 and sandwiches the second section 32 in conjunction with the first contact section 41. For example, the first engaging section 43 covers the second section 32 from the outer side.

The second engaging section 44 is provided at the other end in the width direction of the main body section 40. The second engaging section 44 engages with an end portion 33a in the height direction of the third section 33 and sandwiches the third section 33 in conjunction with the second contact section 42. For example, the second engaging section 44 covers the third section 33 from the outer side.

In this way, the supporting body 21 is covered with the cover 22 from the front surface 31a side to cause the engaging sections 43 and 44 to engage with the second section 32 and the third section 33. Consequently, the cover 22 is attached to the supporting body 21.

The light source module 12 further includes a pair of side plates 27 and 28. The side plate 27 is attached to one ends in the longitudinal direction of the supporting body 21 and the cover 22. The side plate 28 is attached to the other ends in the longitudinal direction of the supporting body 21 and the cover 22. The side plate 27 closes the one end in the longitudinal direction of the cover 22. The side plate 28 closes the other end in the longitudinal direction of the cover 22.

The holding member 23 includes an opposed section 50, a first gripping section 51, and a second gripping section 52. The opposed section 50 is opposed to the rear surface 31b. The opposed section 50 is in contact with, for example, the rear surface 31b. The length in the width direction of the opposed section 50 is substantially the same as or slightly smaller than the length in the width direction of the rear surface 31b.

The first gripping section 51 is provided at one end in the width direction of the opposed section 50. The first gripping section 51 holds and grips the second section 32 and the first engaging section 43. The first gripping section 51 has, for example, a leaf spring shape and holds the second section 32 and the first engaging section 43 to thereby suppress the first engaging section 43 from being disengaged.

The second gripping section 52 is provided at the other end in the width direction of the opposed section 50. The second gripping section 52 holds and grips the third section 33 and the second engaging section 44. The second gripping section 52 has, for example, a leaf spring shape and holds the third section 33 and the second engaging section 44 to thereby suppress the second engaging section 44 from being disengaged. In other words, the holding member 23 suppresses the cover 22 from opening by holing the second and third sections 32 and 33 and the first and second engaging sections 43 and 44.

As explained above, the holding member 23 is attached to the supporting body 21 from the rear surface 31b side, holds the second section 32 and the first engaging section 43 with the first gripping section 51, and holds the third section 33 and the second engaging section 44 with the second gripping section 52 to thereby retain the cover 22 on the supporting body 21.

A first stopper section 53 is provided in the first gripping section 51. The first stopper section 53 engages with a first section to be engaged 32b provided in the second section 32 and regulates movement of the first gripping section 51 in the direction that the rear surface 31b faces (a direction away from the rear surface 31b).

A second stopper section 54 is provided in the second gripping section 52. The second stopper section 54 engages with a second section to be engaged 33b provided in the third section 33 and regulates movement of the second gripping section 52 in the direction that the rear surface 31b faces.

In a state in which the opposed section 50 is set in contact with the rear surface 31b, the stopper sections 53 and 54 are engaged. Consequently, the holding member 23 is retained on the supporting body 21. The holding member 23 is suppressed from coming off the supporting body 21. Therefore, the cover 22 is appropriately retained by the supporting body 21.

In this example, a trio of the holding members 23 are attached to the supporting body 21. Therefore, in the second section 32, a trio of the first sections to be engaged 32b are provided side by side in the longitudinal direction. In the third section 33, a trio of the second sections to be engaged 33b are provided side by side in the longitudinal direction. For example, positions where the first section to be engaged 32b and the second section to be engaged 33b are provided are attaching positions of the holding member 23.

In this example, the first stopper section 53 and the second stopper section 54 are substantially semispherical protrusions projecting to the outer side. The first section to be engaged 32b and the second section to be engaged 33b are substantially rectangular through-holes. On the contrary the first stopper section 53 and the second stopper section 54 may be formed as through-holes and the first section to be engaged 32b and the second section to be engaged 33b may be formed as protrusions. The shapes of the first stopper section 53, the second stopper section 54, the first section to be engaged 32b, and the second section to be engaged 33b may be arbitrary shapes that can suppress the holding member 23 from coming off.

In this example, each of a pair of the first stopper sections 53 and a pair of the second stopper sections 54 is provided side by side in the longitudinal direction. The number of each of the first stopper sections 53 and the second stopper sections 54 is arbitrary. The number of each of the first stopper sections 53 and the second stopper sections 54 may be one or may be three or more.

In the first gripping section 51, a pair of pressing sections 51a and a first claw section 51b are provided. The pressing sections 51a are provided side by side in the longitudinal direction. The pressing sections 51a are sections bent in a substantially U shape to hold the second section 32 and the first engaging section 43. The first claw section 51b is provided between the pressing sections 51a. The first claw section 51b projects in a direction opposite to the opposed section 50 in a direction substantially parallel to the rear surface 31b. For example, the first claw section 51b projects to the outer side in the width direction.

In the second gripping section 52, a pair of pressing sections 52a and a second claw section 52b are provided. The pressing sections 52a are provided side by side in the longitudinal direction. The pressing sections 52a are sections bent in a substantially U shape to hold the third section 33 and the second engaging section 44. The second claw section 52b is provided between the pressing sections 52a. The second claw section 52b projects in the direction opposite to the opposed section 50 in the direction substantially parallel to the rear surface 31b. For example, the second claw section 52b projects to the outer side in the width direction.

The claw sections 51b and 52b are used to attach the light source module 12 to the luminaire main body 16. In this way, the holding member 23 is used to retain the cover 22 and also used to attach the light source module 12 to the luminaire main body 16.

For the holding member 23, a metal material such as iron, aluminum, or stainless steel is used. For the holding member 23, for example, a resin material may be used. However, it is preferable to use the metal material as described above as the holding member 23. Consequently, for example, it is possible to improve durability of the holding member 23. The holding member 23 is formed of, for example, one plate material.

Consequently, for example, it is possible to reduce the number of components. For example, it is possible to suppress costs of the light source module 12. For example, when the resin material is used as the holding member 23, it is preferable that the holding member 23 is one component formed by injection molding or the like.

In the light source module 12, after the board 25 is supported by the supporting body 21, the engaging sections 43 and 44 are engaged to attach the cover 22 to the supporting body 21 and the cover 22 is retained on the supporting body 21 by the holding member 23. One end in the longitudinal direction of the cover 22 is closed by the side plate 27 and the other end in the longitudinal direction of the cover 22 is closed by the side plate 28. Consequently, the light source module 12 is assembled.

The cover 22 is not limitedly retained by the holding member 23 and may be retained on the supporting body 21 by screwing or the like. However, when the cover 22 is retained by the holding member 23, it is possible to assemble the light source module 12 without using a tool or the like. For example, compared with holding the cover 22 using the screws, it is possible to improve assemblability of the light source module 12. Compared with holding the cover 22 using the screws, it is also possible to reduce the number of components. For example, it is possible to reduce costs of the light source module 12.

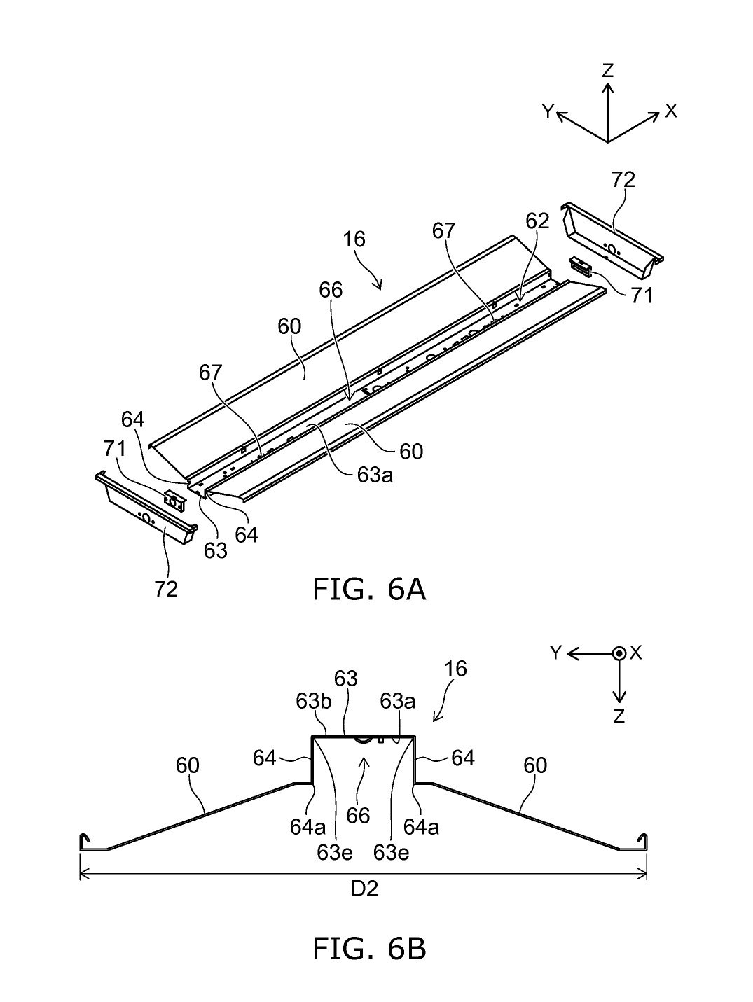

FIG. 6A and FIG. 6B are schematic diagrams of the luminaire main body of the luminaire according to the embodiment.

FIG. 6A is an exploded perspective view of the luminaire main body 16. FIG. 6B is a sectional view of the luminaire main body 16.

As shown in FIG. 1B, FIG. 6A, and FIG. 6B, the luminaire main body 16 includes a pair of reflecting plate sections 60 and a housing section 62. The housing section 62 is provided between the pair of reflecting plate sections 60. The housing section 62 houses at least a part of the power supply device 14.

In this example, the reflecting plate sections 60 are formed integrally with the housing section 62. The reflecting plate sections 60 and the housing section 62 are formed of, for example, one sheet metal. The reflecting plate sections 60 may be attached to the housing section 62 by screwing or the like. The reflecting plate sections 60 may be fixed to the housing section 62 by bonding, welding, or the like. As the luminaire main body 16, a metal material such as iron, aluminum, or stainless steel is used.

The light source module 12 is supported by the luminaire main body 16 with the supporting body 21 opposed to the housing section 62 and covers the housing section 62 and the power supply device 14. The shapes of the reflecting plate sections 60 are substantially the same. That is, in the luminaire main body 16, the light source module 12 is arranged substantially in the center in the width direction.

For example, there is a luminaire in which two light source modules are arranged side by side in the width direction and a power supply device is arranged between the light source modules. In such a luminaire, for example, to suppress degradation of design properties and suppress an electric shock, for example, a member for covering the power supply device is necessary. Therefore, the luminaire includes a large number of components and assembly of the luminaire is complicated. When a plurality of light source modules are used, a color and brightness of irradiation light sometimes vary in each of the modules. Further, a rate of a lighting failure is high.

On the other hand, in the luminaire 10 according to the embodiment, one light source module 12 is arranged substantially in the center in the width direction of the luminaire main body 16. The power supply device 14 and the housing section 62 for the power supply device 14 are covered with the light source module 12. Therefore, in the luminaire 10 according to the embodiment, it is possible to reduce the number of the light source modules 12. For example, a dedicated member for covering the power supply device 14 is unnecessary. In this way, in the luminaire 10, it is possible to reduce the number of components and improve assemblability. Further, according to the reduction in the number of components, it is also possible to suppress costs of the luminaire 10. Since only one light source module 12 has to be provided, it is possible to suppress variation of a color and brightness of irradiation light. It is also possible to suppress a rate of a lighting failure.

An increase in brightness of a light-emitting element such as an LED is under way. In the light source module 12, for example, a high-brightness light-emitting element is used as the light source 26. Consequently, for example, even with one light source module 12, it is possible to obtain brightness equivalent to brightness of two light source modules including low-brightness light sources.

As a luminaire fixture for the ceiling, there is a luminaire in which a reflecting plate and a section for supporting a light source are separate components. In this case, a component for binding the reflecting plate and the supporting section is also necessary. The luminaire includes a large number of components and assembly of the luminaire is complicated. On the other hand, in the luminaire 10 according to the embodiment, the reflecting plate sections 60 are formed integrally with the housing section 62. Therefore, when the luminaire 10 is used as a luminaire fixture for the ceiling, it is possible to further reduce the number of components and further improve assemblability.

Further, when the power supply device 14 is attached to the luminaire main body 16 in which the reflecting plate sections 60 and the housing section 62 are integrated, for example, compared with the luminaire in which the reflecting plate and the supporting section are separate, it is possible to increase a thermal radiation area and improve thermal radiation properties of the power supply device 14.

The housing section 62 includes a bottom plate section 63 and a pair of side plate sections 64. The bottom plate section 63 is arranged to be substantially parallel to the supporting plate 21. The bottom plate section 63 includes a third surface 63a and a fourth surface 63b. The fourth surface 63b is a surface on the opposite side of the third surface 63a. In this example, the fourth surface 63b is substantially parallel to the third surface 63a. The fourth surface 63b may cross the third surface 63b. The bottom plate section 63 extends in a first direction (the longitudinal direction indicated by an arrow X in the figure) parallel to the third surface 63a.

The side plate sections 64 extend substantially perpendicularly to the light source module 12 side from both sides of the bottom plate section 63. In other words, the side plate sections 64 at least extend from one side end 63e of the third surface 63a, which extends in the longitudinal direction, in a second direction (a height direction indicated by an arrow Z in the figure) perpendicular to the third surface 63a. In this example, the side plate sections 64 extend in a direction perpendicular to the third surface 63a. The side plate sections 64 may incline with respect to the third surface 63a. In this example, the side plate sections 64 are substantially parallel to each other. The side plate sections 64 may be non-parallel to each other. The side plate sections 64 only have to have at least a component extending in the height direction.

The housing section 62 houses at least a part of the power supply device 14 in a region 66 surrounded by the bottom plate section 63 and the side plate sections 64. In this example, the power supply device 14 is provided on the third surface 63a. The power supply device 14 is attached to the bottom plate section 63 by screwing or the like. In this example, the entire power supply device 14 is housed in the region 66.

Each of the pair of reflecting plate sections 60 extends from an end portion 64a in the height direction of each of the pair of side plate sections 64 to a direction opposite to the bottom plate section 63 in a third direction (a width direction indicated by an arrow Y) perpendicular to the first direction and the second direction. For example, the reflecting plate sections 60 extend to the outer side of the region 66 in the width direction.

For example, the light source module 12 is provided such that at least a part of the cover 22 is located between the pair of reflecting plate sections 60. At least a part of the reflecting plate sections 60 is opposed to the second plate section 40b and the third plate section 40c (the inclining section) of the light source module 12. The reflecting plate sections 60 incline with respect to the third surface 63a. The reflecting plate sections 60 incline in the same direction as an inclining direction in the second plate section 40b and the third plate section 40c of the light source module 12. That is, the reflecting plate sections 60 are bent to the light emitting direction side. A distance D2 in the width direction between the reflecting plate sections 60 continuously increases in a direction from the third surface 63a to the light source module 12. One of the reflecting plate sections 60 and the second plate section 40b may be substantially parallel to each other or may be not parallel to each other. The other of the reflecting plate sections 60 and the third plate section 40c may be substantially parallel to each other or may be not parallel to each other. That is, the “same direction” only has to be a direction in which the reflecting plate sections 60 expand to at least the light emitting direction side.

One of the reflecting plate sections 60 is opposed to the second plate section 40b of the cover 22 of the light source module 12. The other of the reflecting plate sections 60 is opposed to the third plate section 40c. Consequently, lights emitted from the second plate section 40b and the third plate section 40c are reflected on the reflecting plate sections 60 and travel to the indoor side. Consequently, for example, it is possible to suppress darkness from occurring on the ceiling side. For example, the reflecting plate sections 60 may be substantially parallel to the third surface 63a.

In the luminaire main body 16, for example, an attaching section 67 and a terminal block 68 are further provided. The attaching section 67 is used to attach the luminaire 10 to an attachment target such as the ceiling. The attaching section 67 is provided on the bottom plate section 63. In this example, the attaching section 67 is an attachment hole like a through-hole for inserting a metal fitting such as a hanging bolt or a screw. In this example, a pair of the attaching sections 67 arranged side by side in the longitudinal direction are provided on the bottom plate section 63. The number of the bottom plate sections 63 may be one or may be three or more.

The terminal block 68 is attached to the bottom plate section 63 by screwing or the like. The terminal block 68 is used to, for example, electrically connect an external power supply and the power supply device 14 and electrically connect the power supply device 14 and the light sources 26 (the wiring layer of the board 25).

In the bottom plate section 63, for example, a plurality of openings for inserting power supply cables or the like for supplying electric power to the power supply device 14 are further provided.

The luminaire main body 16 further includes a pair of first end plates 71 (end plates) and a pair of second end plates 72. The first end plates 71 are respectively attached to end portions in the longitudinal direction of the luminaire main body 16 and close the end portion sides of the housing section 62. More specifically, the first end plates 71 are respectively attached to a pair of end portions in the longitudinal direction of the housing section 62, enter between the side plate sections 64, and close end portions in the longitudinal direction of the housing section 62. The first end plates 71 can be attached to the housing section 62 to be variable in the up down direction according to an external dimension of at least one of the luminaire main body 16 and the light source module 12. The second end plates 72 are respectively attached to pairs of end portions in the longitudinal direction of the housing section 62 and the reflecting plate sections 60. The second end plates 72 cover the end portions in the longitudinal direction of the housing section 62 and the reflecting plate sections 60. The second end plates 72 cover the first end plates 71 attached to the housing section 62.

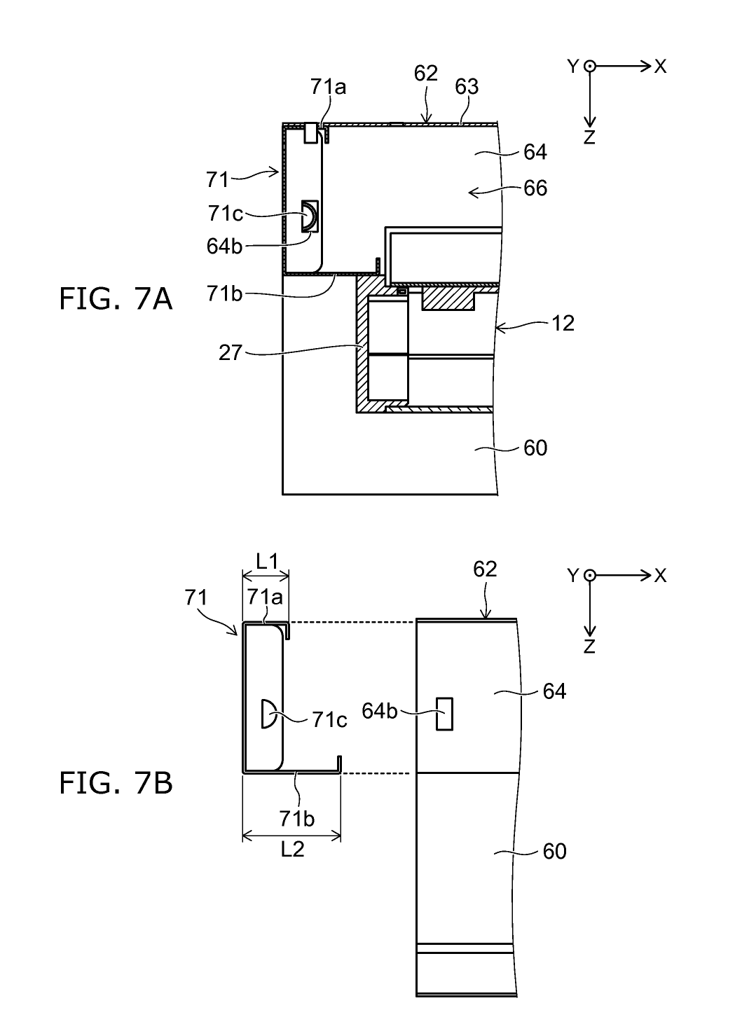

FIG. 7A and FIG. 7B are schematic diagrams showing a part of the luminaire according to the embodiment.

FIG. 7A is a partial sectional view schematically showing one end in the longitudinal direction of the luminaire 10. FIG. 7B is a partial side view schematically showing one end in the longitudinal direction of the luminaire 10. The other end in the longitudinal direction of the luminaire 10 is substantially the one end shown in FIG. 7A and FIG. 7B. Therefore, the other end is not shown in the figures.

As shown in FIG. 7A and FIG. 7B, the first end plate 71 includes a first projecting section 71a and a second projecting section 71b. The first projecting section 71a is provided at one end in the height direction and extends in the longitudinal direction to the region 66 side. The second projecting section 71b is provided at one end in the height direction and extends in the longitudinal direction to the region 66 side. Length L1 in the longitudinal direction of the first projecting section 71a is different from length L2 in the longitudinal direction of the second projecting section 71b. In this example, the length L2 is longer than the length L1. The length L1 may be longer than the length L2.

The first end plate 71 covers, with the first projecting section 71a or the second projecting section 71b, a gap formed between an end portion in the longitudinal direction of the housing section 62 and the light source module 12. In this example, the second projecting section 71b covers the gap formed between the end portion in the longitudinal direction of the housing section 62 and the light source module 12. Consequently, the first end plate 71 suppresses visual recognition of the inside of the region 66 or the like from the indoor side. Consequently, for example, it is possible to improve design properties of the luminaire 10.

In the first end plate 71, the first projecting section 71a or the second projecting section 71b overlaps, for example, an end portion in the longitudinal direction of the light source module 12 in the height direction. The first projecting section 71a or the second projecting section 71b is in contact with, for example, the end portion in the longitudinal direction of the light source module 12. In this example, the second projecting section 71b is in contact with the side plate 27 of the light source module 12. Consequently, for example, when the light source module 12 is attached to the luminaire main body 16, the first end plate 71 supports the end portion in the longitudinal direction of the light source module 12.

The length in the width direction of the first projecting section 71a and the length in the width direction of the second projecting section 71b are substantially the same as the distance in the width direction between the side plate sections 64. Consequently, the first end plate 71 suppresses, for example, deformation of the side plate sections 64. For example, the first end plate 71 suppresses the distance in the width direction between the side plate sections 64 from decreasing.

In the case of the embedded luminaire, for example, the dimensions of an attaching section (e.g., an embedding hole) on the ceiling side are different depending on building. Therefore, in the embedded luminaire, a plurality of products having different lengths in the longitudinal direction are prepared. In this case, the dimensions of the luminaire main body 16 need to be changed according to the dimensions on the ceiling side. It is desirable to change the dimensions of the light source module 12 as well. However, when a plurality of kinds of the light source modules 12 having different dimensions are prepared, for example, manufacturing costs increase. Therefore, the light source module 12 is used in common to, for example, the luminaire main bodies 16 having different dimensions. In this case, the gap formed between the end portion in the longitudinal direction of the housing section 62 and the light source module 12 changes according to the dimensions of the luminaire main body 16.

For example, in a first product, as shown in FIG. 7A, the first end plate 71 is attached to the housing section 62 with the second projecting section 71b directed to the light source module 12 side. In a second product longer in the longitudinal direction than the first product, contrary to the FIG. 7A, the first end plate 71 is attached to the housing section 62 with the first projecting section 71a directed to the light source module 12 side. Consequently, for example, the first end plate 71 can be used in common in two products having different lengths in the longitudinal direction. For example, it is possible to reduce the number of components for each of models. For example, it is possible to further suppress manufacturing costs.

One kind of the luminaire main body 16 is sometimes used in common to a plurality of kinds of the light source modules 12 having different brightnesses and colors of irradiation lights. For example, when the plurality of kinds of the light source modules 12 having different lengths in the longitudinal direction are attached to the luminaire main body 16, an attaching direction of the first end plate 71 may be changed according to the lengths of the light source modules 12.

The first end plate 71 includes an engaging section 71c configured to engage with sections to be engaged 64b provided in the side plate sections 64. The first end plate 71 is retained in the housing section 62 according to the engagement of the section to be engaged 64b and the engaging section 71c. The position in the height direction of the engaging section 71c deviates from the center in the height direction of the first end plate 71. The position in the height direction of the section to be engaged 64b is determined according to the attaching direction of the first end plate 71. Consequently, for example, it is possible to suppress the first end plate 71 from being attached in a wrong direction.

In this example, the engaging section 71c is a substantially semispherical protrusion projecting to the outer side. The section to be engaged 64b is a substantially rectangular through-hole. On the contrary, the engaging section 71c may be formed as a through-hole and the section to be engaged 64b may be formed as a protrusion. The shape of each of the engaging section 71c and the section to be engaged 64b may be an arbitrary shape that can retain the first end plate 71.

A deviation amount of the engaging section 71c from the center in the height direction of the first end plate 71 only has to be set to a degree for enabling suppression of reversible attachment. When the direction of the attachment of the first end plate 71 is changed according to the length of the light source module 12, the engaging section 71c may be arranged near the center in the height direction of the first end plate 71 and the first end plate 71 may be reversibly attached to the housing section 62.

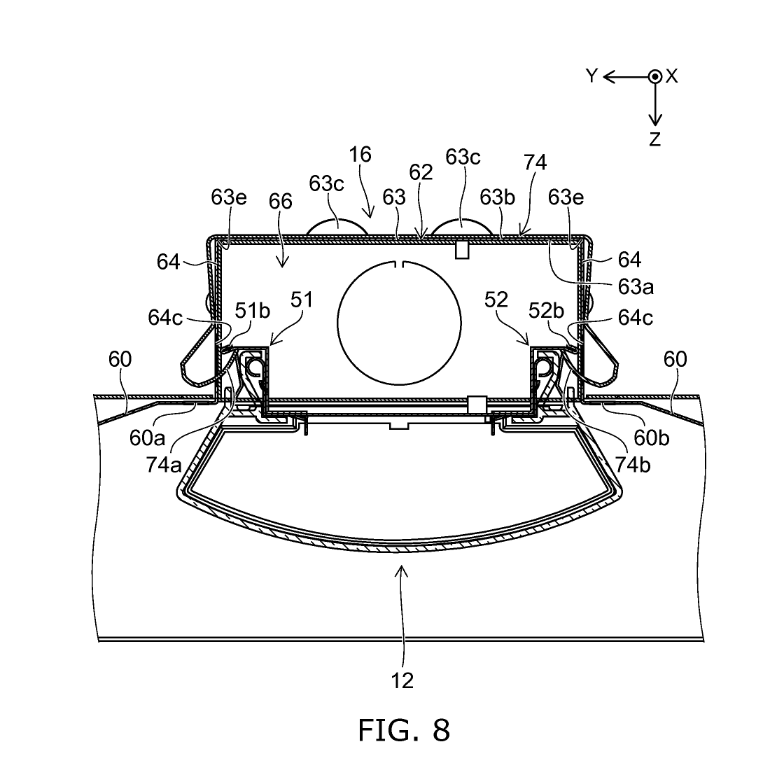

FIG. 8 is a partial sectional view schematically showing a part of the luminaire according to the embodiment.

As shown in FIG. 8, a part of the light source module 12 is housed in the region 66 of the luminaire main body 16. For example, the first gripping section 51 and the second gripping section 52 of the holding member 23 are housed in the region 66.

The luminaire main body 16 includes an attachment spring 74. The attachment spring 74 is attached to the fourth surface 63b of the bottom plate section 63. That is, the attachment spring 74 is attached to the outer side of the region 66. The attachment spring 74 is attached to the fourth surface 63b by screws, rivets, or the like. The attachment spring 74 is bent in a substantially U shape and includes a section extending along the bottom plate section 63 and a section extending along the side plate sections 64. The attachment spring 74 engages with the first claw section 51b and the second claw section 52b of the light source module 12 housed in the region 66 and regulates movement of the light source module 12 in a direction in which the light source module 12 comes off the region 66.

As explained above, in the luminaire main body 16, the light source module 12 is supported by engaging the attachment spring 74 with the claw sections 51b and 52b. In this example, the three holding members 23 are provided in the light source module 12. Therefore, in this example, a trio of the attachment springs 74 are provided in the luminaire main body 16. In the luminaire main body 16, the attachment springs 74 are attached to positions corresponding to the holding members 23 of the light source module 12. In the luminaire main body 16, the light source module 12 is supported by engaging the attachment springs 74 respectively with the claw sections 51b and 52b of the holding members 23.

For the attachment spring 74, a metal material such as iron, aluminum, or stainless steel is used. The attachment spring 74 has elasticity. The attachment spring 74 is a so-called leaf spring. For the attachment spring 74, for example, a resin material may be used. However, for example, durability can be improved by using the metal material as the attachment spring 74.

An opening 64c is provided in each of the side plate sections 64. The opening 64c is arranged in a position opposed to the first gripping section 51 or the second gripping section 52 in the width direction. In this example, a trio of the openings 64c are provided in each of the side plate sections 64 to respectively correspond to the three holding members 23 of the light source module 12 (see FIG. 1B).

One end portion 74a of the attachment spring 74 is bent in a substantially U shape and enters the region 66 via the opening 64c. The end portion 74a engages with the first claw section 51b of the light source module 12 housed in the region 66.

The other end portion 74b of the attachment spring 74 is bent in a substantially U shape and enters the region 66 via the opening 64c. The end portion 74b engages with the second claw section 52b of the light source module 12 housed in the region 66.

For example, when the light source module is attached to the luminaire main body by screws, screw heads are exposed to the indoor side. When the light source module is screwed, a tool is necessary for the attachment and assembly is complicated.

On the other hand, in the luminaire 10 according to the embodiment, the light source module 12 is supported by the attachment spring 74. When the attachment spring 74 supports the light source module 12, the attachment spring 74 is covered with the light source module 12. Consequently, in the attachment spring 74, for example, it is possible to suppress a member for supporting the light source module 12 from being exposed to the indoor side. For example, it is possible to improve design properties of the luminaire 10. A tool or the like is unnecessary for attachment of the attachment spring 74. It is possible to cause the luminaire main body 16 to support the light source module 12 simply by fitting the light source module 12 in the region 66. Consequently, it is possible to further improve assemblability of the luminaire 10.

In the luminaire 10, openings 64c are provided in the side plate sections 64. The attachment spring 74 enters the region 66 via the openings 64c. By providing the openings 64c in the side plate sections 64 in this way, it is possible to more appropriately suppress the openings 64c and the attachment spring 74 from being exposed to the indoor side.

When the reflecting plate sections 60 have a taper shape inclining to the indoor side, the openings provided in the side plate sections 64 are arranged further on the upper side than the center in the height direction of the luminaire main body 16. Consequently, it is possible to arrange the light source module 12 substantially in the center in the height direction of the luminaire main body 16. Consequently, for example, it is possible to suppress a decrease in illuminance due to luminous intensity distribution of the reflecting plate sections 60. For example, it is possible to suppress the light source module 12 from extending further downward than the reflecting plate sections 60 to cause glare.

In the luminaire main body 16, for example, the positions in the height direction of the openings 64c are adjusted such that the board 25 is set near the end portions 64a of the side plate sections 64. For example, the distance in the height direction between the first surface 25a of the board 25 and the end portions 64a of the side plate sections 64 is set to be equal to or smaller than 20 mm. Consequently, it is possible to appropriately suppress a decrease in illuminance and occurrence of glare.

In this example, the attachment spring 74 includes the end portion 74a that engages with the first claw section 51b and the end portion 74b that engages with the second claw section 52b. The attachment spring 74 may be configured, for example, by two components, i.e., a component including an end portion that engages with the first claw section 51b and another component including an end portion that engages with the second claw section 52b.

In the reflecting plate sections 60, openings 60a and openings 60b are provided. The openings 60a are arranged in the positions opposed to the end portion 74a of the attachment spring 74 in the height direction. The openings 60b are arranged in the positions opposed to the end portion 74b of the attachment spring 74 in the height direction. The openings 60a and 60b are provided to correspond to the attachment springs 74. In this example, a trio of the openings 60a and a trio of the openings 60b are provided in the reflecting plate sections 60.

A bar-like jig is inserted into the opening 60a to push the end portion 74a of the attachment spring 74 and elastically deform the attachment spring 74. Then, the end portion 74a moves in a direction of retraction from the region 66 along the inclination of the end portion 74a. The first claw section 51b and the end portion 74a are disengaged.

The bar-like jig is inserted into the opening 60b to push the end portion 74b of the attachment spring 74 and elastically deform the attachment spring 74. Then, the end portion 74b moves in a direction of retraction from the region 66 along the inclination of the end portion 74b. The second claw section 52b and the end portion 74b are disengaged.

As explained above, the luminaire main body 16 detachably supports the light source module 12 according to the engagement and disengagement of the attachment spring 74.

As explained above, in the cover 22 of the light source module 12, the shape of the main body section 40 viewed in the longitudinal direction is the fan shape. The openings 60a and 60b of the reflecting plate sections 60 overlap the main body section 40 in the height direction. Consequently, for example, when viewed from the indoor side, it is possible to make it difficult to visually recognize the openings 60a and 60b. For example, it is possible to improve design properties of the luminaire 10.

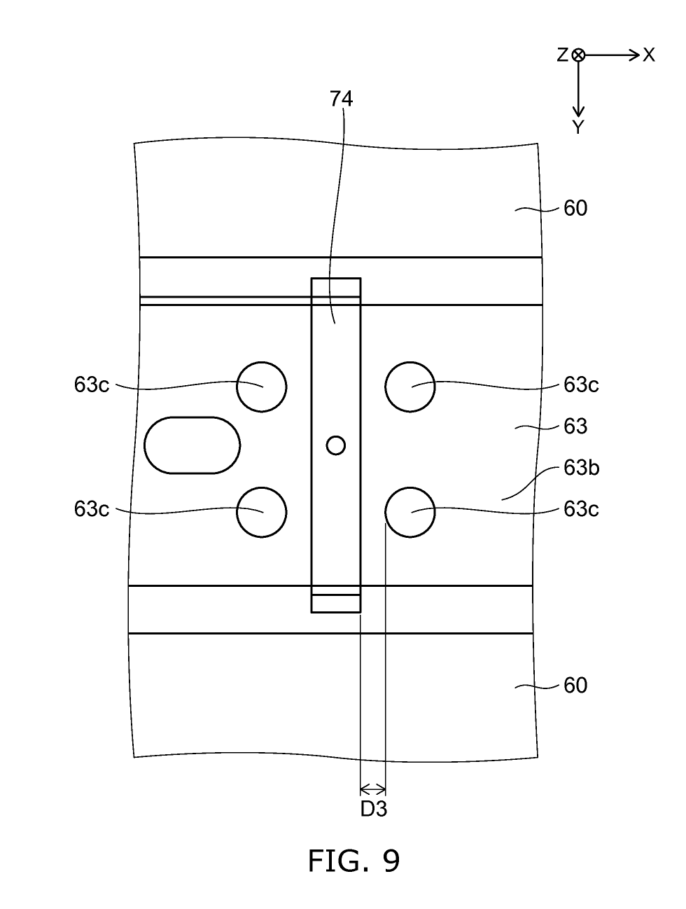

FIG. 9 is a partial plan view schematically showing a part of the luminaire according to the embodiment.

As shown in FIG. 8 and FIG. 9, a protrusion 63c is provided on the fourth surface 63b of the bottom plate section 63. For example, a plurality of the protrusions 63c are provided on the fourth surface 63b. The number of the protrusions 63c may be arbitrary. The number of the protrusions 63c may be one. In this example, the protrusion 63c has a semispherical shape. The shape of the protrusion 63c is not limited to the semispherical shape and may be an arbitrary shape projecting in a direction that the fourth surface 63b faces. The height (the length in the height direction from the fourth surface 63b) of the protrusion 63c is, for example, equal to or larger than the thickness of the attachment spring 74.

The protrusion 63c is arranged near the attachment spring 74. A distance D3 in the longitudinal direction between the protrusion 63c and the attachment spring 74 is, for example, equal to or smaller than 30 mm. That is, “near the attachment spring 74” means that the distance D3 is equal to or smaller than 30 mm. In this example, the plurality of protrusions 63c are arranged on both sides in the longitudinal direction of the attachment spring 74. The protrusions 63c may be provided only on one side in the longitudinal direction of the attachment spring 74.

For example, when the luminaire 10 is used as an embedded luminaire, metal fittings such as hanging bolts are attached to the luminaire main body 16. The luminaire main body 16 is attached to embedding holes on the ceiling or the like. When the luminaire 10 is used as a luminaire fixture for the ceiling, in a state in which the protrusions 63c are set in contact with the ceiling surface, the luminaire main body 16 is screwed to a ceiling plate or the like from the indoor side.

For example, when the luminaire 10 is used as the luminaire fixture for the ceiling, the protrusions 63c form a gap between the ceiling surface and the fourth surface 63b of the bottom plate section 63. Consequently, for example, it is possible to suppress screws or the like from coming into contact with the ceiling surface. For example, it is possible to improve adhesion between the luminaire main body 16 and the ceiling surface. For example, it is possible to suppress the screws or the like from coming into point-contact with the ceiling surface to deform the luminaire main body 16.

In the luminaire main body 16, for example, at least two chains for suppressing a drop of the light source module 12 are provided. For example, the two chains are provided near both ends in the longitudinal direction of the luminaire main body 16. For example, a plurality of hooks corresponding to the chains are provided on the rear surface 31b of the supporting body 21 of the light source module 12. After the luminaire main body 16 is attached to the ceiling, end portions of the chains are hung on the hooks of the light source module 12 to suspend the light source module 12.

After the light source module 12 is suspended, for example, the light source module 12 and the power supply device 14 are electrically connected by connecting a not-shown connector to the light source module 12.

After the wiring, in a state in which the light source module 12 is tilted, the second section 32 side of the supporting body 21 is put in the region 66. The first claw sections 51b of the holding members 23 are respectively engaged with the end portions 74a of the attachment springs 74. Thereafter, the third section 33 side of the supporting body 21 is input in the region 66 to reset the light source module 12 to be horizontal. The second claw sections 52b of the holding members 23 are respectively engaged with the end portions 74b of the attachment springs 74.

Consequently, the light source module 12 is supported by the luminaire main body 16. The luminaire 10 is attached to the ceiling. It is also possible that, after the second claw sections 52b are engaged with the end portions 74b, the first claw sections 51b are engaged with the end portions 74a.

When the light source module 12 is detached from the luminaire main body 16, for example, after the first claw sections 51b and the end portions 74a are respectively disengaged, the second claw sections 52b and the end portions 74b are respectively disengaged. It is also possible that, after the second claw sections 52b and the end portions 74b are respectively disengaged, the first claw sections 51b and the end portions 74a are respectively disengaged.

When the luminaire 10 is used as the luminaire fixture for the ceiling and the luminaire main body 16 is screwed to the ceiling plate or the like, for example, screws are sometimes excessively tightened to deform the luminaire main body 16. When the attachment spring 74 is engaged to support the light source module 12, if the luminaire main body 16 is deformed, for example, the positions of the attachment spring 74 and the claw sections 51b and 52b deviate. Consequently, it is difficult to attach the light source module 12 to and detach the light source module 12 from the luminaire main body 16.

In the luminaire 10 according to the embodiment, the protrusion 63c is provided near the attachment spring 74 of the bottom plate section 63. In the luminaire 10, when the luminaire main body 16 is screwed to the ceiling surface, the protrusion 63c comes into contact with the ceiling surface. Consequently, in the luminaire 10, it is possible to suppress deformation of the luminaire main body 16 near the attachment spring 74. For example, it is possible to easily perform attachment and detachment of the light source module 12 to and from the luminaire main body 16. For example, it is possible to ease attach the luminaire main body 16 to an attachment target such as the ceiling.

It is possible to more appropriately suppress deformation of the luminaire main body 16 by providing the plurality of protrusions 63c. It is possible to further suppress deformation of the luminaire main body 16 by arranging the protrusions 63c on both the sides in the longitudinal direction of the attachment spring 74.

For example, the distance D3 is set to 20 mm or less. Consequently, it is possible to more appropriately suppress deformation of the luminaire main body 16. For example, the distance D3 is set to 10 mm or less. Consequently, it is possible to further suppress deformation of the luminaire main body 16.

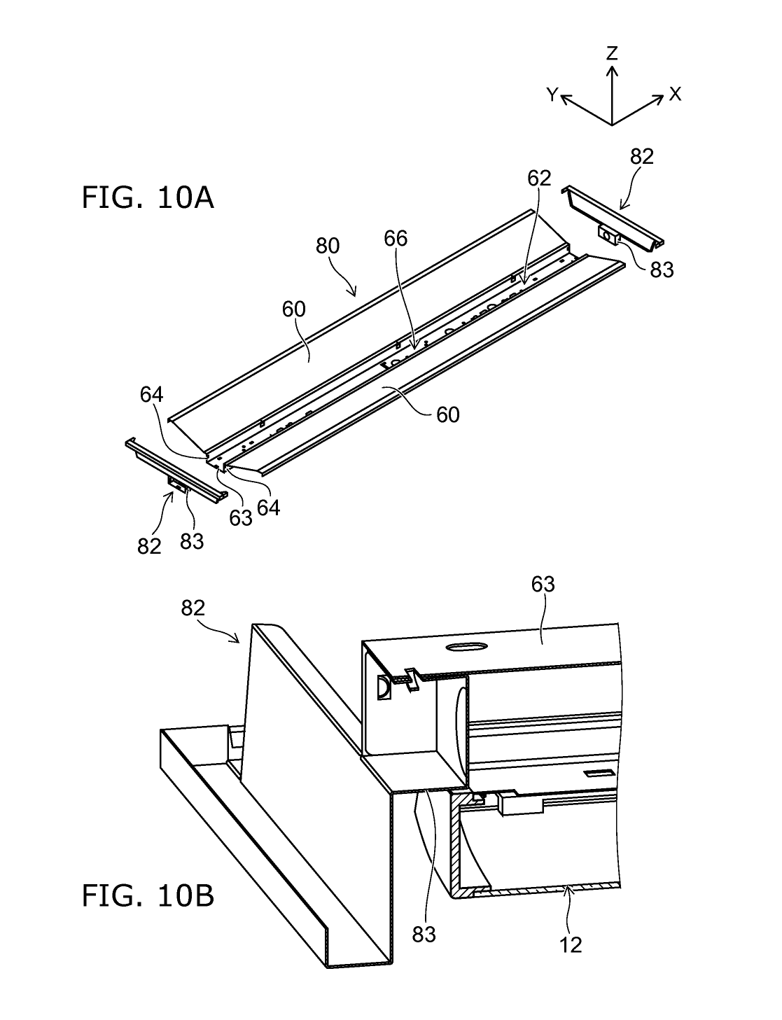

FIG. 10A and FIG. 10B are schematic diagrams showing another luminaire main body of the luminaire according to the embodiment.

FIG. 10A is an exploded perspective view of another luminaire main body 80. FIG. 10B is a perspective view showing a part of the luminaire main body 80.

As shown in FIG. 10A and FIG. 10B, the luminaire main body 80 in this example includes a pair of end plates 82.

The end plates 82 are respectively attached to the pairs of end portions in the longitudinal direction of the housing section 62 and the reflecting plate sections 60. The end plates 82 cover the end portions in the longitudinal direction of the housing section 62 and the reflecting plate sections 60. The end plates 82 include projecting sections 83 extending in the longitudinal direction to the region 66 side and entering between the side plate sections 64.

The end plates 82 cover, with the projecting sections 83, a gap formed between the end portion in the longitudinal direction of the housing section 62 and the light source module 12. The end plates 82 suppress visual recognition of the inside of the region 66 or the like from the indoor side and improve design properties of the luminaire 10. For example, the projecting sections 83 overlap the end portion in the longitudinal direction of the light source module 12 in the height direction. For example, the projecting section 83 comes into contact with the end portion in the longitudinal direction of the light source module 12. For example, when the light source module 12 is attached to the luminaire main body 16, the end plates 82 support the end portion in the longitudinal direction of the light source module 12. The length in the width direction of the projecting section 83 is substantially the same as the distance in the width direction between the side plate sections 64. For example, the end plates 82 suppress deformation of the side plate sections 64. For example, the end plates 82 suppress the distance in the width direction between the side plate sections 64 from decreasing.

That is, the end plates 82 are obtained by integrating the first end plates 71 and the second end plates 72. When the end plates 82 are used, compared with attaching the first end plates 71 and the second end plates 72 to the luminaire main body 16, it is possible to further reduce the number of components of the luminaire 10. For example, it is possible to further improve assemblability of the luminaire 10.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a long-shaped light source module including a board, a light source provided on the board, a supporting body configured to support the board, and a light transmissive cover configured to cover the board;
a power supply device configured to supply electric power to the light source module; and
a long-shaped luminaire main body provided with the light source module and the power supply device,
the luminaire main body including a pair of reflecting plate sections and a housing section provided between the pair of reflecting plate sections and configured to house at least a part of the power supply device, and
the light source module being provided in the luminaire main body with the supporting body opposed to the housing section and covering the housing section and the power supply device.

2. The luminaire according to claim 1, wherein
the housing section includes a bottom plate section disposed to be parallel to the supporting body and a pair of side plate sections extending from both sides of the bottom plate section to the light source module,
at least a part of the power supply device is housed in a region surrounded by the bottom plate section and the pair of side plate sections, and
each of the pair of reflecting plate sections continues from an end side on an opposite side to the bottom plate section in the pair of side plate sections.

3. The luminaire according to claim 1, wherein
the light source module is provided such that at least a part of the cover is located between the pair of reflecting plate sections,
the cover includes an inclining section inclining to expand from the board in an emitting direction of light of the light source, and
the inclining section and at least a part of the pair of reflecting plate sections are provided to be opposed to each other.

4. The luminaire according to claim 3, wherein the pair of reflecting plate sections inclines in a direction same as the inclining direction in the inclining section of the light source module.

5. The luminaire according to claim 2, wherein
the luminaire main body further includes a pair of first end plates respectively attached to end portions in a longitudinal direction and closing the end portion of the housing section, and
the pair of first end plates can be attached to be variable in an up down direction according to an external dimension of at least one of the luminaire main body and the light source module.

6. The luminaire according to claim 5, wherein
the pair of first end plates include engaging sections configured to engage with sections to be engaged provided in the pair of side plate sections, and
arrangement positions of the engaging sections deviate from a center in a height direction of the first end plates.

7. The luminaire according to claim 5, wherein
each of the pair of first end plates includes a first projecting section and a second projecting section,
the first projecting section is provided at one end in a height direction and extends in the longitudinal direction to the region,
the second projecting section is provided at one other end in the height direction and extends in the longitudinal direction to the region, and
a length in the longitudinal direction of the first projecting section is different from a length in the longitudinal direction of the second projecting section.

8. The luminaire according to claim 7, wherein each of the pair of first end plates covers, with the first projecting section or the second projecting section, a gap formed between an end portion in the longitudinal direction of the housing section and the light source module.

9. The luminaire according to claim 7, wherein each of the pair of first end plates sets the first projecting section or the second projecting section in contact with an end portion in the longitudinal direction of the light source module and supports the end portion in the longitudinal direction of the light source module.

10. The luminaire according to claim 7, wherein a length in a width direction of the first projecting section and a length in the width direction of the second projecting section are the same as a distance in the width direction between the pair of side plate sections.

11. The luminaire according to claim 5, wherein
the luminaire main body further includes a pair of second end plates, and
each of the pair of second end plates is attached to end portions in the longitudinal direction of the housing section and the pair of reflecting plate sections, covers the end portions in the longitudinal direction of the housing section and the pair of reflecting plate sections, and covers the pair of first end plates attached to the housing section.

12. The luminaire according to claim 1, wherein the luminaire main body includes a pair of end plates attached to each of end portions in a longitudinal direction of the housing section and the pair of reflecting plate sections and configured to integrally close the end portion of the housing section and the pair of reflecting plate sections.

13. The luminaire according to claim 12, wherein each of the pair of end plates includes a projecting section extending in the longitudinal direction to the region and configured to cover a gap formed between an end portion in the longitudinal direction of the housing section and the light source module.

14. The luminaire according to claim 13, wherein each of the pair of end plates sets the projecting section in contact with an end portion in the longitudinal direction of the light source module and supports the end portion in the longitudinal direction of the light source module.

15. The luminaire according to claim 13, wherein a length in a width direction of the projecting section is the same as a distance in the width direction between the pair of side plate sections.

16. The luminaire according to claim 2, wherein
the luminaire main body includes an attachment spring configured to engage with the light source module and support the light source module, and
the attachment spring is attached to the bottom plate section, enters the region via an opening provided in each of the pair of side plate sections, and engages with the light source module.

17. The luminaire according to claim 16, wherein a distance in the height direction between a surface of the board on which the light source is provided and end portions in a height direction of the pair of side plate sections is equal to or smaller than 20 mm.

18. The luminaire according to claim 16, wherein
the bottom plate section includes a protrusion provided on a surface facing an opposite side of the region, and
a height of the protrusion is equal to or larger than a thickness of the attachment spring.

19. The luminaire according to claim 18, wherein a distance in the longitudinal direction between the protrusion and the attachment spring is equal to or smaller than 30 mm.

20. The luminaire according to claim 18, wherein
a plurality of the protrusions are provided on the bottom plate section, and
the plurality of protrusions are arranged on both sides in the longitudinal direction of the attachment spring.
